(19) United States
(12) Patent Application Publication
(10) Pub. No.: US 2014/0243008 A1
(43) Pub. Date: Aug. 28, 2014

(54) LOAD BALANCING FOR CHARGING SYSTEM CLUSTERS

(71) Applicant: Bo Wang, Shanghai Shanghai (CN)

(72) Inventor: Bo Wang, Shanghai Shanghai (CN)

(21) Appl. No.: 14/351,715

(22) PCT Filed: Oct. 25, 2011
(86) PCT No.: PCT/CN2011/001773

§ 371 Date: Apr. 14, 2014

(51) Int. Cl. H04W 28/08; H04W 4/24

(52) U.S. Cl. CPC H04W 28/08; H04W 4/24
USPC 455/453

(57) ABSTRACT

A method for load balancing for charging system clusters includes, with a load balancing system, receiving a request from a mobile device, maintaining load data related to current loads for a plurality of charging system clusters communicatively coupled to the load balancing system, and forwarding the request to one of the plurality of charging system clusters based on the load data.

### BACKGROUND

Mobile devices such as smart-phones, tablet computers, and notebook computers often access a variety of services over a network. Such a network may be available to these devices wirelessly. The same networks that are used to provide service to mobile phone devices are also used to provide internet access to devices. Such internet connections are currently referred to as 3G (Third Generation) wireless networks.

To make use of such systems, a subscriber typically establishes a billing relationship with a provider of such networks. The subscriber's device may be identified through a number of methods such as use of a serial number. When that subscriber uses the network to access various services over the network with his or her device, the network provided can track those service and charge the subscriber accordingly for use of those services.

Various charging schemes may be used to charge the subscriber. For example, the subscriber may pre-pay for a certain number of services. Alternatively a subscriber may elect to be billed later for services consumed. The systems which track the services used by a mobile device for charging purposes are referred to as charging systems. These charging systems are responsible transaction handling, rating, online correlation and management of subscriber accounts/balances.

### BRIEF DESCRIPTION OF THE DRAWINGS

The accompanying drawings illustrate various examples of the principles described herein and are a part of the specification. The drawings are merely examples and do not limit the scope of the claims.

FIG. 1 is a diagram showing an illustrative load balancing system, according to one example of principles described herein.

FIG. 2 is a diagram showing an illustrative charging system, according to one example of principles described herein.

FIG. 3 is a flowchart showing an illustrative load balancing process, according to one example of principles described herein.

FIG. 4 is a diagram showing an illustrative service request forwarding process, according to one example of principles described herein.

FIG. 5 is a diagram showing an illustrative partition caching process, according to one example of principles described herein.

FIG. 6 is a flowchart showing an illustrative method for load balancing of charging system clusters, according to one example of principles described hereto.

Throughout the drawings, identical reference numbers designate similar, but not necessarily identical, elements.

### DETAILED DESCRIPTION

As mentioned above, charging systems are used to keep track of the services used by a particular consumer device for the purposes of charging the subscriber for such uses. As many networks provide services to large amounts of consumer devices, several different instances of a charging system may be used. When a mobile device sends a request for a service to the network, that request may be forwarded to one instance of a charging system. These charging system instances are referred to as charging system clusters. A charging system cluster may include one or more nodes that are responsible for performing charging transactions.

The charging system cluster to which a service request is forwarded typically depends on characteristics such as the current location of the mobile device. Alternately, the service request may be forwarded to a particular charging system cluster based on the serial number associated with the requesting device. Such static approaches become less efficient as the number of mobile devices utilizing network resources increases.

In light of this and other issues, the present specification discloses methods and systems for dynamically balancing the load between multiple charging system clusters. According to certain illustrative examples, a load balancer serves as an access point to a charging system. The load balancer maintains a record of the current load level of the multiple charging system clusters. The load balancer can then forward an incoming service request to one of the charging system clusters based on that load level data.

For example, a service request may generally be forwarded to the charging system cluster that currently has the smallest load level. However, other factors may be considered as well. For example, not all charging system clusters may be equipped to handle the process of charging for services originating from particular mobile devices. Thus, the load balancer considers whether a particular charging system cluster is able to handle a particular sender request.

Additionally, multiple mobile devices may share a billing relationship for particular services. Particularly, a set of devices may share a data plan. In such cases, any use of such data services may be charged to the same account. Thus, it would be more efficient for multiple service requests belonging to the same service sharing plan to be forwarded to the same charging system cluster.

Through use of methods and systems embodying principles described herein, a more efficient manner of managing the charging process for network service requests is realized. By dynamically forwarding service requests among the multiple charging system clusters, various performance issues are eliminated. For example, if service requests are forwarded to a particular charging system cluster based on geographic location, then a particular event in that location which causes a large amount of people to utilize network service may overload the system. This is avoided trough the dynamic load balancing methods descried herein.

In the following description, for purposes of explanation, numerous specific details are set forth in order to provide a thorough understanding of the present systems and methods. It is apparent, however to one skilled in the art that the present apparatus, systems and methods may be practiced without these specific details. Reference in the specification to “an example” or similar language means that a particular feature, structure, or characteristic described in connection with that example is included as described, but may not be included in other examples.

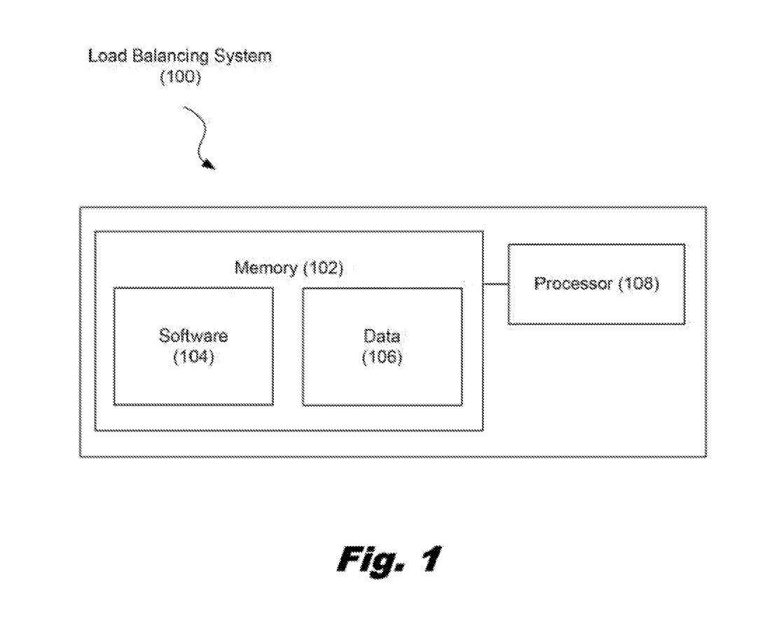

Referring now to the figures, FIG. 1 is a diagram showing an illustrative load balancing system (100) that may he used to forward service requests to one of several charging system clusters. According to certain illustrates examples, the load balancing system (100) includes a memory (102) having machine-readable instructions (104) and data (106) stored thereon. The load balancing system (100) also includes a processor (108).

There are many types of memory available. Some types of memory, such as solid slate drives, are designed for storage. These types of memory typically have large storage volume but relatively slow performance. Other types of memory, such as those used for Random Access Memory (RAM), are optimized for speed and are often referred to as “working memory.” The various forms or memory may store information in the form of machine-readable instructions (104) and data (106).

The load balancing system (100) also includes a processor (108) for executing the machine-readable instructions (104) and using or updating the data (106) stored in memory (102). The machine-readable instructions (104) may include an operating system. An operating system allows other applications to interact properly with the hardware of the load balancing system. Such other applications may include those for maintaining various data about the multiple charging systems to which the load balancer may forward requests. Such data may allow the load balancing system to dynamically forward such requests.

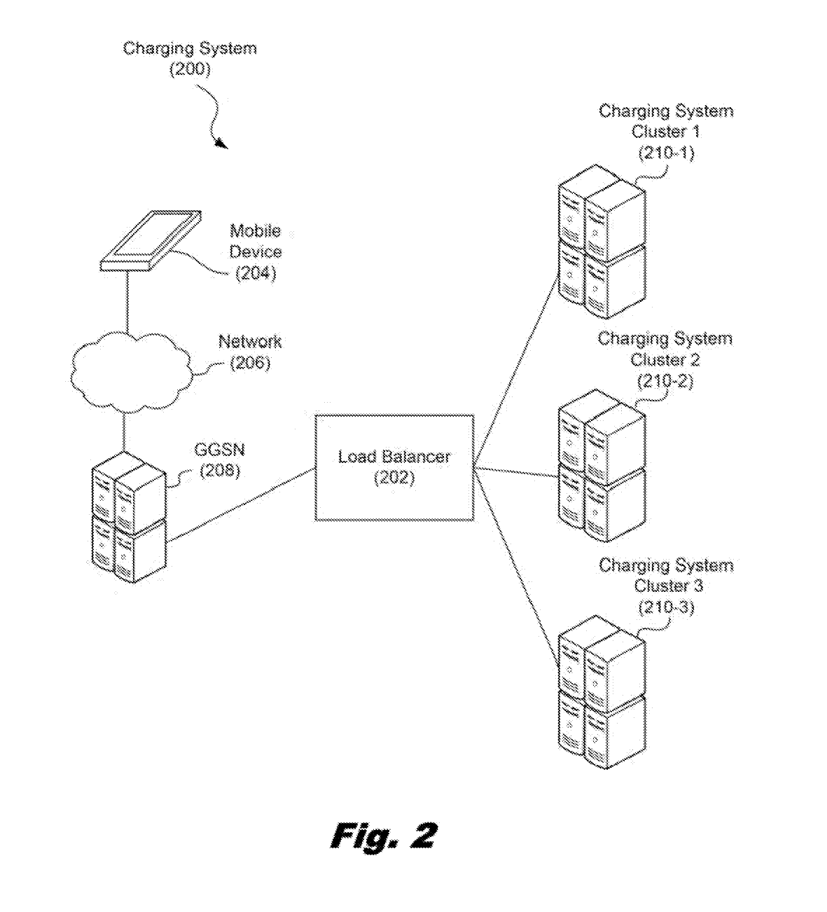

FIG. 2 is a diagram showing an illustrative charging system (200). According to certain illustrative examples, the charging system (200) includes a load balancer (202) and a number of charging system clusters (210). A mobile device (204) is connected to the charging system through a General Packet Radio Service (GPRS) network (206). A Gateway GPRS Service Node (GGSN) (206) bridges the GPRS network (206) to the load balancer of the charging system (200).

Various mobile devices (204) such as mobile smart-phones and tablet devices are able to utilize various services from a network. Such services may include voice calls, text messaging, and internet access. Such services involve transmission of data over wireless networks (206). These wireless networks (206) are structured as a number of access points, often referred to as cell towers. Each cell tower corresponds to a particular cell. When a mobile device is within a particular cell, it communicates with the cell tower of that cell. When the mobile device roams into a different cell, then the mobile device switches cells. Thus, the device stops communicating with the old cell tower and begins communicating with the new cell tower corresponding to the different cell.

In order for a mobile device to access various data related services available over the Internet the service request goes through the GGSN (208). The GGSN (208) allows data that is transmitted over the cell tower network (206) to interface with external switched networks such as the internet. In order to charge the subscriber for the service being requested, the request is first sent to a charging system.

Various types of charging systems may be used. One type of charging systems is an online charging system. An online charging system, as opposed to an offline charging system, allows the service provider to charge the user in real time as the service is being accessed. By charging the subscriber in real time, the service provider can avoid revenue leakage. Revenue leakage occurs when consumers access particular services but do not end up paying for those services. An online charging system offers online control capabilities. Furthermore an online charging system provides a unified charging engine for all network services.

Online charging systems may use a mechanism referred to as credit control. Credit control directly interacts with a subscriber's account in real-time and controls or monitors any charges that are related to service usage. This credit control involves a variety of functions including determining whether credit is available, reserving credit, deducting credit upon completion of service usage, and returning of unused reserved credit. Online Charging System is the entity that performs real-time credit control.

A charging system (200) may include several clusters (210). Each cluster (210) is capable of performing the charging functions associated with the charging system. Such an implementation provides for scalability as new clusters may be added to handle larger volumes of service subscribers.

When the charging system receives a service request, it is then determined which charging system cluster (210) handles that service request. A load balancer (202) is used to determine which charging system cluster processes an incoming service request, in the example shown in FIG 2, the load balancer decides between charging system cluster 1 (210-1), charging system cluster 2 (210-2), and charging system cluster 3 (210-3).

As mentioned above, load balancers (202) typically forward a service request to a particular charging cluster (210) based on a particular characteristic of the service request. For example, the service request may be forwarded based on the geographic location of the mobile device (204) sending the request. However, such a static approach may not result in a well balanced load between the clusters (210). This is because it may be the case that more mobile devices (204) within a particular geographic location are requesting services at a particular time than are the mobile devices (204) at a different geographic location. In light of this issue, the present specification discloses a more dynamic approach to balancing the load among multiple charging system charging clusters (210).

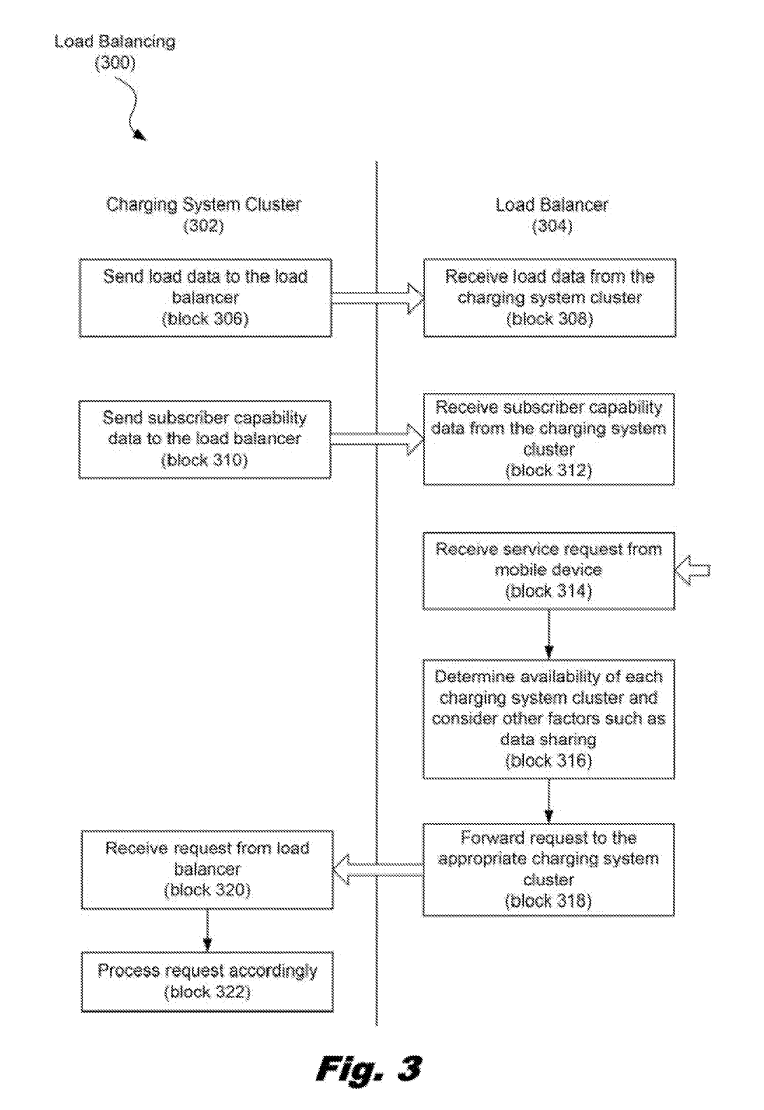

FIG. 3 is a flowchart showing an illustrative load balancing process (300). According to certain illustrative examples, the load balancer forwards requests to the different charging system clusters based on a variety of factors. The blocks on the left represent actions performed by a charging system cluster (302) while the blocks on the right represent actions performed by the load balancer (304).

The charging system cluster (305) sends (block 306) load data to the load balancer (306). This data is then received (block 308) by the load balancer in one example, this data may be in the form of an attribute value pair. The value of the attribute value pair may range from 0-10. A value of 0 may indicate that the charge system cluster (302) is not busy at all. Conversely, a value of 10 may indicate that the charging system cluster (302) is completely loaded, in some cases the load data may be sent to the load balancer (304) at regular intervals. In some oases, the load data may only be sent to the load balancer when there is a change in the value. By being aware of the current load levels of each of the charging system clusters, the load balancer can make more dynamic decisions as to which cluster to forward an incoming service request.

The charging system cluster (302) also sends (block 310) subscriber capability data to the load balancer (304). The subscriber capability data is then received (block 312) by the load balancer (304). The subscriber capability data indicates for what subscribers a particular charging system cluster is able to process. Specifically, a particular charging system cluster may not have subscriber information for particular subscribers and is thus able to process any charging transactions for that subscriber.

In some cases, a new changing system cluster may be added to the system to handle increasing subscriber volume. In such cases, the new charging system cluster indicates its presence to the load balancer. The new charging system then sends the load balancer its subscriber capably data. Thus, the load balancer becomes aware of what requests can be handled by the new charging system. Such a system allows for batter scalability of the charging system because the load balancer is already designed to receive this data during runtime and does not need to be shut down to add new charging system clusters.

During the normal course of operation, the load balancer receives (block 314) a services request from a mobile device. The load balancer then determines (block 316) the availability of each charging system cluster. For example, it may be the case that some charging system clusters are completely loaded. Thus it is better to forward the request to another charging system cluster that is capable of handling the charging transactions for the subscriber associated with the service request.

The load balancer may also take into other factors to allow for a more dynamic forwarding approach. For example, it may be more efficient to forward requests from mobile devices within the same service plan to the same charging system cluster. This reduces the amount of collaboration between the various clusters which have to update the subscriber account data accordingly.

After the load balancer (304) determines which charging system cluster to send the request, it then forwards (block 318) that request to the charging system cluster (302). That request is then received (block 320) by the charging system cluster (302). The charging system cluster (302) then processes (block 322) the request accordingly.

In one example, the communications between the load balancer and the charging system clusters may be done using diameter protocol. Diameter protocol is an authentication, authorization, and accounting protocol. It builds off of the Remote Authentication Dial-in User Service (RADIUS) protocol. The diameter protocol includes exchange requests referred to as Capability Exchange Request (CER) and Capability Exchange Answer (CEA) The CER and CEA may be used to communicate various data such as the load level and subscriber capability data.

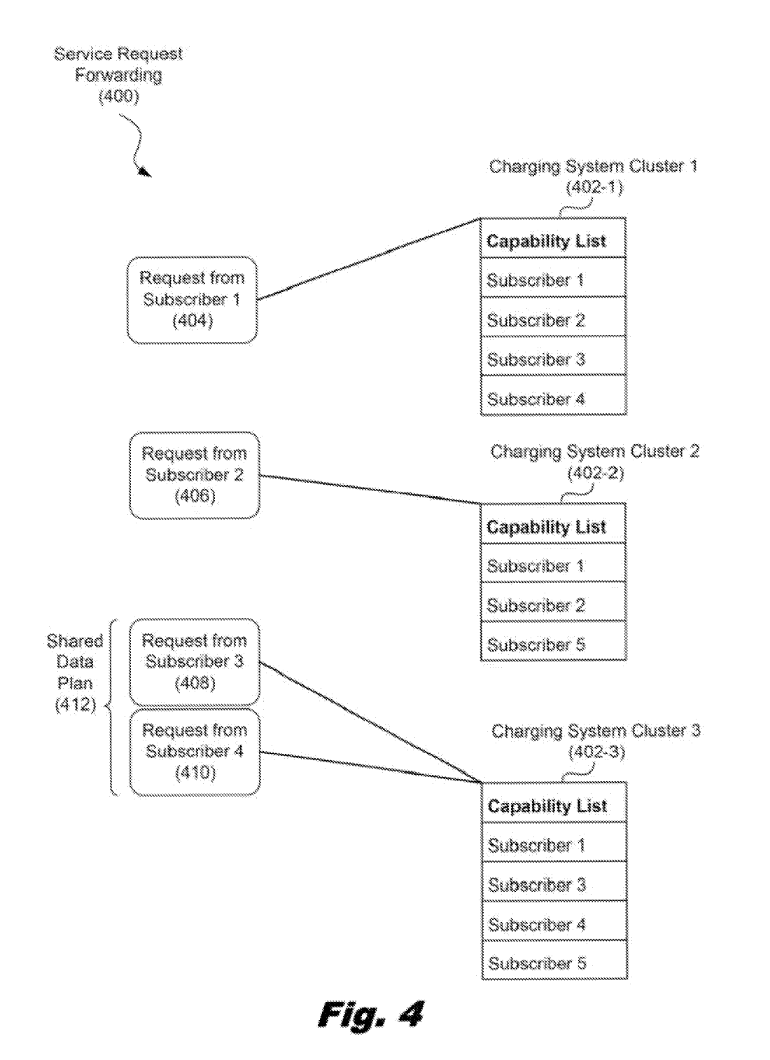

FIG. 4 is a diagram showing an illustrative service request forwarding process. As mentioned above, different charging system clusters are able to handle different subscriber charging transactions. The capability list, which indicates which subscribers a particular charging system can handle, is displayed for three different charging system dusters (402). This illustration is for purposes of explanation. Practical charging system clusters are able to handle much larger numbers of subscribers.

Charging system cluster 1 (402-1) includes the ability to handle charging transactions for subscribers 1, 2, 3, and 4. Charging system cluster 2 (402-2) includes the ability to handle charging transactions for subscribers 1, 2, and 6. Charging system cluster 3 (405-3) includes the ability to handle charging transactions for subscribers 1, 3, 4, and 5.

In one example, the load balancer receives a service request (404) from subscriber 1. Each of the charging system clusters is capable of handling a request for subscriber 1. In this example, the load balancer may decide to send the request to changing system cluster 1 (402-1).

In a further example, the load balancer receives a service request (406) from subscriber 2. Both charging system cluster 1 (402-1) and charging system cluster 2 (402-2) are capable of handling this request. At this point, charging system cluster 2 (402-2) is less busy than charging system cluster 1 (402-1). Thus, the request may be forwarded to charging system duster 2 (402-2).

The system also receives a service request (408) from subscriber 3. Both charging system cluster 1 (402-1) and charging system cluster 3 (402-3) are capable of handling this request. At this point, charging system cluster 3 (402-3) is less busy than charging system cluster 1 (402-1). Thus, the request may be forwarded to charging system cluster 3 (402-3).

The system also receives a service request (410) from subscriber 4. Subscriber 3 and subscriber 4 have a shared data plan (412). Thus, although both charging system cluster 1 (402-1) and charging system cluster 3 (402-3) are capable of handling the service request, the load balancer forwards the request to charging system cluster 3 (402-3). This may be done even if other charging system clusters are less busy than charging system cluster 3 (402-3).

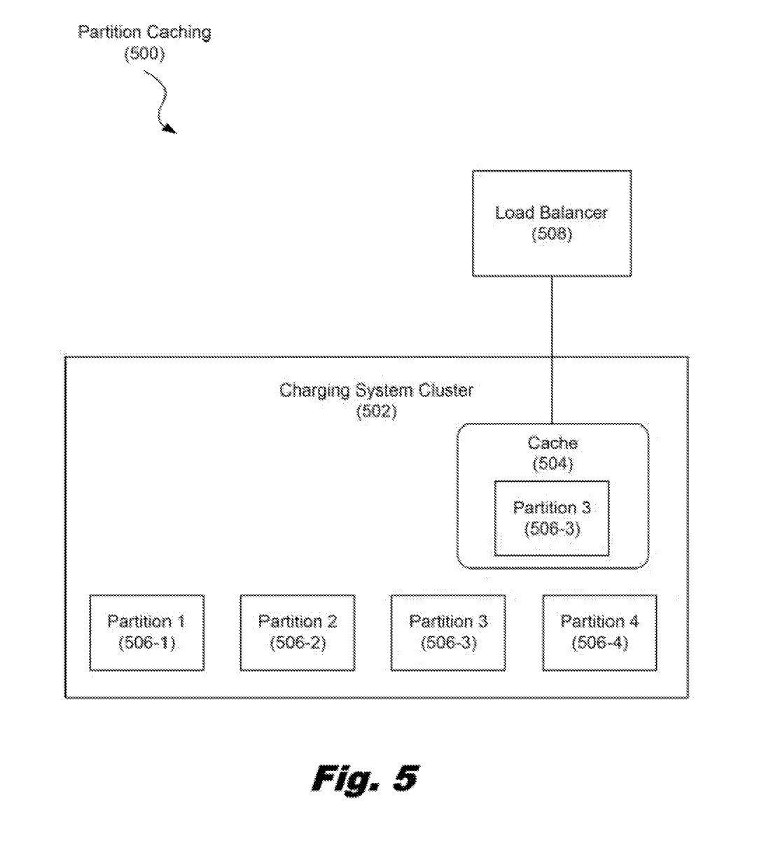

FIG. 5 is a diagram showing an illustrative partition caching process (300). According to certain illustrative examples, the subscriber data that is stored by a changing system cluster (502) may be divided into partitions. The manner of partitioning the data may be such that it may make use of a caching system. A cache (504) is a temporary memory that allows fast access to data therein. For example, if the load balancer (508) sends a service request that involves charging transactions associated with a particular subscriber, then the partition storing data for that subscriber is placed into the cache (504).

If a subsequent service request uses subscriber data from that same partition that is in the cache (504), then that service request may be processed more quickly. However, if a subsequent service request evolves subscriber data that is not within the cache (504), then the charging system cluster retrieves the appropriate partition to perform the desired charging process. In addition, that partition may replace an older partition that is currently within the cache (504).

In the example shown in FIG. 5, the subscriber data is divided into four partitions (506-1, 508-2, 508-3, 506-4). The cache (504) includes space for one of those partitions. However, a practical charging system cluster includes a much larger number of partitions. Furthermore, a practical caching system is able to hold a much larger number of partitions.

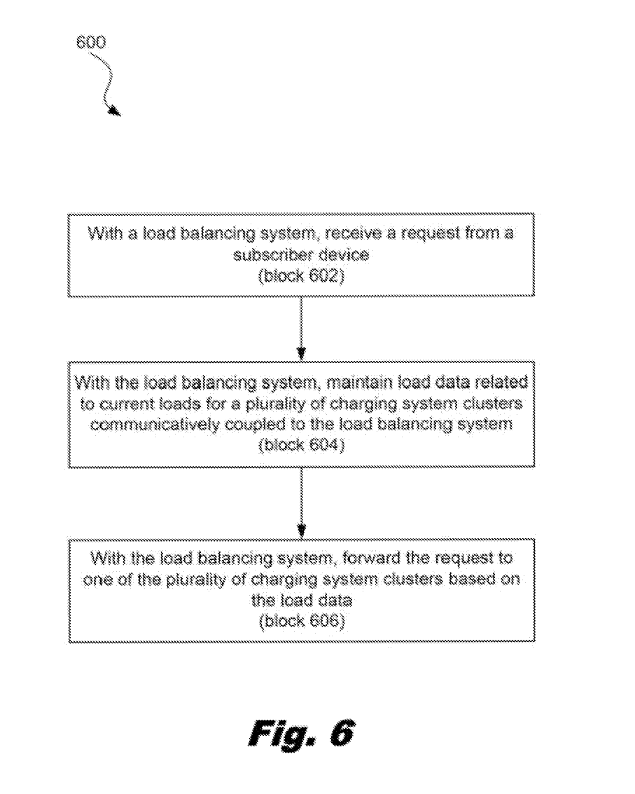

FIG. 6 is a flowchart showing an illustrative method for load balancing of charging system clusters. According to certain illustrative examples, the method (600) includes, with a load balancing system, receiving (block 602) a request from a subscriber device, with the load balancing system, maintaining (block 604) load data related to current loads for a plurality of charging system clusters communicatively coupled to the load balancing system, and with the load balancing system forwarding (block 606) the request to one of the plurality of charging system clusters based on the load data.

In conclusion, through use of methods and systems embodying principles described herein, a more efficient manner of managing the charging process for network service requests is realized. By dynamically forwarding service requests among the multiple charging system dusters, various performance issues are eliminated. For example, if service requests are forwarded to a particular charging system cluster based on geographic location, then a particular event in that location which causes a large amount of people to utilize network services may overload the system. This is avoided through the dynamic load balancing methods described herein.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A method for load balancing for charging system clusters, the method comprising:
with a load balancing system receiving a request from a mobile device
with said load balancing system, maintaining load data related to current loads for a plurality of charging system clusters communicatively coupled to said load balancing system, and
with said load balancing system forwarding said request to one of said plurality of charging system clusters based on said load data.

2. The method of claim 1, wherein forwarding said request is based on a data sharing group associated with said mobile device.

3. The method of claim 1, further comprising, receiving from one of said plurality of charging system clusters, data related to current load levels of that charging system cluster.

4. The method of claim 1, further comprising, receiving from one of said plurality of charging system clusters, data indicating which mobile devices can have requests processed by that cluster.

5. The method of claim 1, further comprising:
receiving an indication from a new charging system cluster that said new charging system cluster intends to join said plurality of charging system clusters, and
receiving a subscriber capability list from said new charging system cluster indicating a set of mobile devices from which requests can be handled by said new charging system cluster.

6. The method of claim 1, wherein data stored within one of said charging system clysters that indicates which subscriber requests can be handled by that charging system cluster is divided into partitions in a manner so as to allow caching of said partitions.

7. The method of claim 1 wherein said load balancing system utilizes diameter protocol to communicate with said charging system clusters.

8. A computing system comprising;
at least one processor;
a memory communicatively coupled to the at least one processor, the memory comprising computer executable code that, when executed by the at least one processor, causes the at least one processor to:
receive a request from a mobile device;
maintain load data related to current loads for a plurality of charging system clusters communicatively coupled to said load balancing system; and
forward said request to one of said plurality of charging system dusters based on sad load data.

9. The system of claim 8, where to forward said request, said processer is further to consider a data sharing group associated with said mobile device.

10. The system of claim 8, wherein said processor is further to receive from one of said plurality of charging system clusters, data related to current load levels of that charging system cluster.

11. The system of claim 8, wherein said at least one processor is further to receive from one of said plurality of charging system clusters, data indicating which mobile devices can have requests processed by that cluster.

12. The system of claim 8, wherein said at least one processor is further to:
receive an indication from a now charging system duster that said now charging system cluster intends to join said plurality of charging system clusters, and
receive a subscriber capability list from said new charging system cluster indicating a set of mobile devices from which analysis can be handled by said new charging system cluster.

13. The system of claim 8, wherein data stored within one of said charging system clusters that indicates which subscriber requests can be handled by that charging system cluster is divided into partitions in a manner so as to allow caching of said partitions.

14. The system of claim 8, wherein said system utilizes diameter protocol to communicate with said charging system clusters.

15. A method for load balancing between charging system clusters, the method comprising:
with a load balancing system, receiving a request from a mobile device, said mobile device being associated with a subscriber.
with said load balancing system, receiving load data from a plurality of charging system clusters, said load data indicating current load levels of said charging system clusters;
with said load balancing system, receiving subscriber capability data from said charging system clusters, said subscriber capability data indicating which subscribers for which said charging system clusters can process service requests; and
with said load balancing system, forwarding said service request to one of said plurality of charging system clusters based on said load data and said subscriber capability data.
